(19) United States
(12) Patent Application Publication
(10) Pub. No.: US 2002/0066467 A1
(43) Pub. Date: Jun. 6, 2002

(54) Method and apparatus for cleaning a substrate

(76) Inventors: Paul De Ruijter, ES Reuver (NL); Eugene A. Swain, Webster, NY (US); Robert E. McCumiskey, Rochester, NY (US); James Hoemer, Rochester, NY (US); Richard C. Petralia, Rochester, NY (US)

Correspondence Address: Henry I. Steckler, Perman & Green, LLP, 425 Post Road, Fairfield, CT, 06430, US

(21) Appl. No.: 09/730,292

(22) Filed: Dec. 5, 2000

(51) Int. Cl. B08B 1/00

(52) U.S. Cl. 134/6; 15/21.1; 15/88; 15/88.4

(57) ABSTRACT

The apparatus of claim 30, further comprising a container having said brush and said cleaning element dispersed and an apparatus brush cleans the inside surface of a cylindrical photoreceptor substrate such as used in xerography. The substrate can be in a cleaning solution and brushes can also be located both inside and outside the substrate. There is relative motion, e.g., rotation, translation, a combination of both, etc., between the brushes and the substrate. A photoreceptor coating is directly applied after the cleaning without intervening processing steps.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to cleaning substrates, and more particularly, to cylindrical substrates as used in photocopying machines.

2. Description of the Related Art Including Information Disclosed Under 37 CFR 1.97 and 1.98

At present, primary cleaning of substrates is done by their supplier. At the user the outside surface of a cylindrical substrate is further cleaned before a photoreceptor coating is applied. In particular, in the cleaning system, a plurality of substrates are loaded onto rigid spindles, which are located on a lowering device (LD). Once placed onto the spindle, the lowerator first lowers the substrates into a deionized (DI) water rinse tank to remove residual transportation dirt, e.g., lint, dust, etc., and residual honing media, e.g., Al₂0₃ beads. Then the substrates are moved down through a series of wash and rinse tanks, through an oven, and onto a transfer mechanism that takes the substrates into the series of coatings. However, this allows contaminants, typically 25 μm or less in size, to be present on the inside substrate surfaces, especially on the lower half of the substrates. These contaminants can migrate into the coating fluid or to the outside surfaces, thereby causing defects in the coating layers. In turn, this causes higher unit manufacturing costs.

It is therefore desirable to have method and apparatus for cleaning at least the inside surface of a cylindrical substrate.

It is also desirable to have method and apparatus for cleaning a substrate just before a coating is applied.

### BRIEF SUMMARY OF THE INVENTION

A method comprises brushing the inside surface of a cylindrical photoreceptor substrate.

An apparatus comprises a brush for cleaning an inside surface of a cylindrical substrate photoreceptor.

A method comprises cleaning the inside surface of a cylindrical photoreceptor substrate; and directly coating the outside surface of said substrate with a photoconductor.

An apparatus comprises a brush for cleaning the inside surface of a cylindrical substrate; and a coater for coating the outside surface of said substrate with a photoconductor.

### BRIEF DESCRIPTION OF THE SEVERAL VIEWS OF THE DRAWING(S)

FIG. 1 is an elevational view of a first embodiment of the invention;

FIG. 2 is a bottom view of FIG. 1;

FIG. 3 is a plan view of a second embodiment;

FIG. 4 is a top view of the second embodiment;

FIG. 5 is a plan view of a third embodiment; and

FIG. 6 is a cross-sectional view of a coating apparatus.

In the figures, corresponding elements have been given corresponding reference numbers.

### DETAILED DESCRIPTION OF THE INVENTION

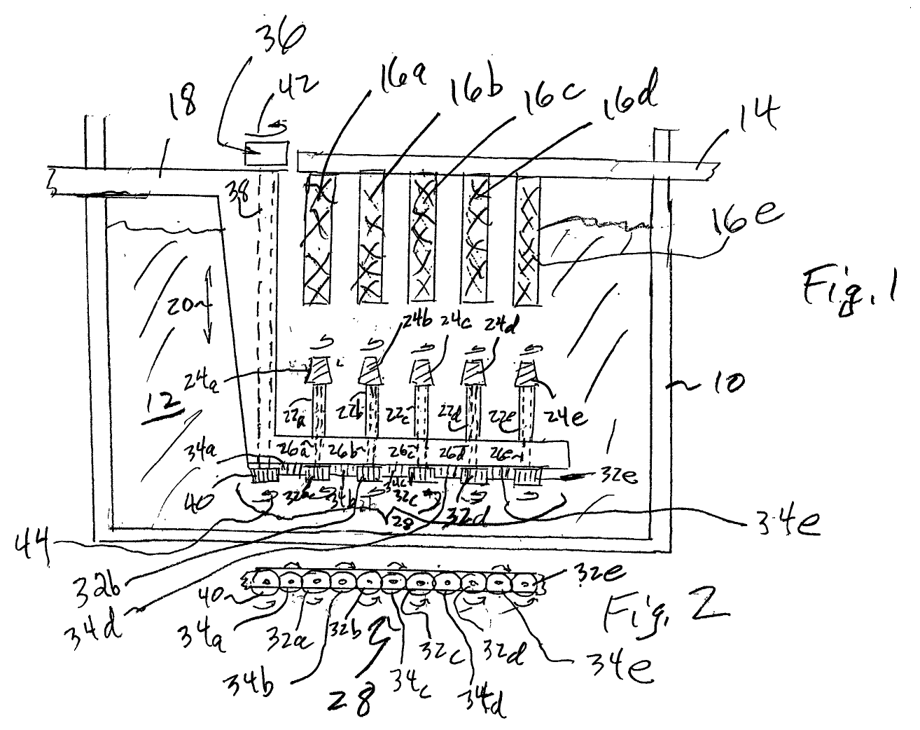

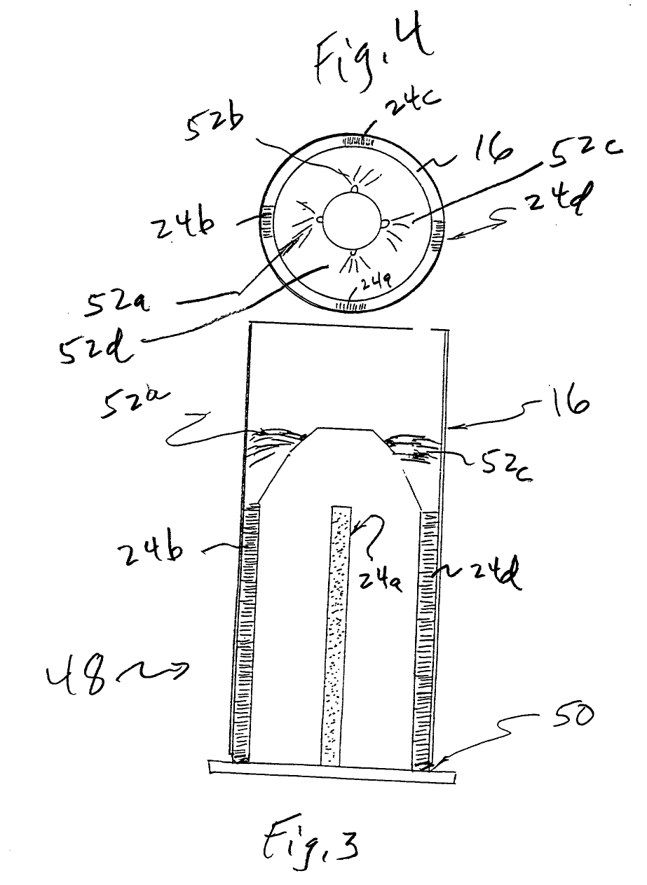

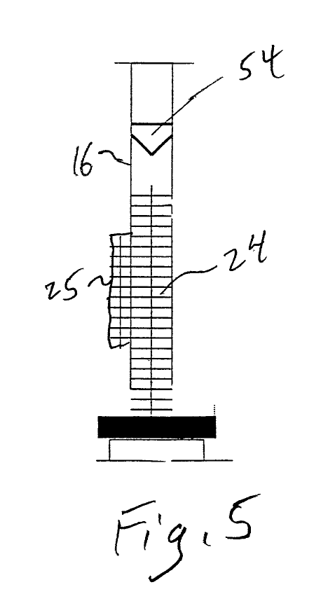

FIG. 1 shows a tank 10 having deionized water rinse 12. A robot or loader arm 14 fixedly holds at least one of a plurality of right circular cylindrical substrates 16a, 16b, 16c, 16d, and 16e to be cleaned. Cylinders 16 can have other shapes, e.g., elliptical, etc., and be other than right angle cylinders. LD 18 is coupled to a device (not shown) for moving it up and down as indicated by arrow 20. A plurality of spindles 22a, 22b, 22c, 22d, and 22e are disposed at the bottom of LD 18 respectively in alignment with substrates 16a, 16b, 16c, 16d and 16e. In accordance with one embodiment of the invention, brushes 24a, 24b, 24c, 24d, and 24e having about the diameter of the interior dimension of the substrates 16 and a selected, e.g. about two inches, length are placed at the top of each spindle 22. The bristles (not shown) of brushes 24 are preferably arranged in a helical pattern for best particle removal. The brushes 24 are preferably made of a material that leaves no residue on substrates 16, e.g., a polyamide thermoplastic. Shafts 26a, 26b, 26c, 26d, and 26e (shown in dotted lines) respectively support brushes 24 and respectively extend through spindles 22 and mate with a drive mechanism 28 disposed on the bottom of the lowerator 18. As best seen in FIG. 2, drive mechanism 28 comprises a plurality of drive gears 32a, 32b, 32c, 32d and 32e respectively coupled to shafts 26. Disposed respectively between drive gears 32 are idler gears 34a, 34b, 34c, 34d, and 34e. An air-operated motor 36 (or any other type) is disposed on top of LD 18 and is connected to a shaft 38 (shown in dotted lines). In turn, shaft 38 is connected to a drive gear 40, which engages idler gear 34a.

In operation, motor 36 rotates shaft 38 as indicated by arrow 42. In turn, shaft 38 rotates driver gear 40 as indicated by arrow 44. Thus, spindles 22 rotate causing rotation of the brushes 24 inside of the substrates 16 during substrate lowering onto the brushes 24 of LD 18. This drives particulates down, thus cleaning the inside of substrates 16.

It will be appreciated that brushes 24 have both rotational and translational motion with respect to the inside surfaces of substrates 16. This results in the best cleaning action. However, if desired, the rotation of brushes 24 can be delayed until the substrates 16 are fully seated. Thus, said relative motion is only rotational. This will clean the inner surfaces provided brushes 24 have a length about at least equal to that of substrates 16. Also, there can be no rotation of brushes 24 at all. Thus, said relative motion is only translational. Optionally, between cleaning cycles, a set of rakes (not shown) will contact the bristles to keep them from matting, thereby maintaining optimum cleaning capability. If desired, the normally present plurality of further wash and rinse tanks can also be provided with the invention. In this case the brushes 24 can be mounted at different heights to ensure the removal of stubborn particulate.

As shown in the second embodiment of FIG. 3, the additional cleaning mechanism 48 is a combination substrate holder and brush 24. This device 48 is utilized to transport the substrate 16 into the cleaning chamber, e.g., tank 10 of FIG. 1, at which time an inflatable chucking device (not shown) grips the substrate 16 near the top and begins to rotate. This rotation is accomplished slightly above the resting point of the substrate on the holder as indicated by clearance gap 50. This is to prevent the bottom of the substrate 16 from rubbing on the holder 48. As the substrate rotates, the brushes scrub the interior of the substrate 16 while rinse water is sprayed 52 from the top of the holder. This will provide the mechanical action needed to remove the residual honing beads. The rotating substrate 16 is now transported by the same chucking device into the brush wash (not shown) where the outsides are cleaned. It can be seen that by simply adding brushes 24 and a spray rinse 52 to the substrate holder extra cleaning can be achieved with little additional equipment.

FIG. 5 shows a third embodiment of the invention. Substrate 16 is mounted on stationary inside brush 24 using an inflatable chuck 54. Outside brush 25 engages the outer surface of substrate 16, both brushes 24 and 25 are submerged in a cleaning liquid or solution. This is preferably a pH neutral solution such as sold under the name “NC201” by Aldon Corporation. This can also be used in the other embodiments. Substrate 16 is rotated for simultaneously cleaning both inside and outside surfaces of substrate 16.

The comments concerning relative motion made above in conjunction with the first embodiment also are pertinent to the second and third embodiments.

After all wash and rinse steps as described above for any of the embodiments, substrates 16 are coated with a photoreconductive material as known in the art. Preferably, the coating step occurs directly after said cleaning step, i.e., while there can be a transporting or conveying step, the inside surface cleaning step is the last processing step before coating so as to prevent further contamination.

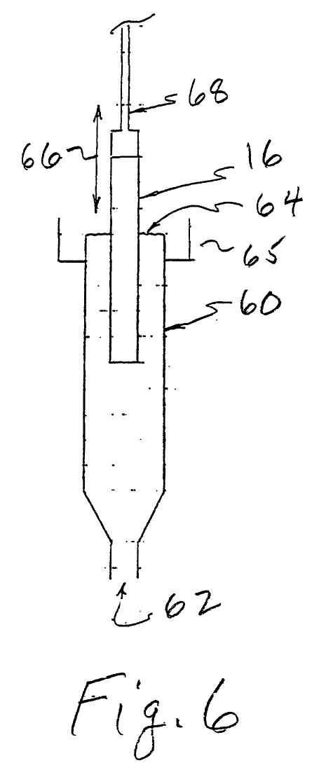

FIG. 6 shows a coating apparatus which comprises a dip coating tank 60 having a coating fluid input 62 at the bottom and filled with a coating solution up to level 64. An overflow container 65 extends around tank 60. Substrate 6 is coated by lowering it into tank 60 by chuck or holder 68 which is attached to a lowering device (not shown). This is indicated by arrow 66. After coating takes place, it is upwardly withdrawn by chuck 68 as is also indicated by arrow 68.

While the present invention has been particularly described with respect to preferred embodiments, it will be understood that the invention is not limited to these particular preferred embodiments, the process steps, the sequence, or the final structures depicted in the drawings. On the contrary, it is intended to cover all alternative, modifications, and equivalents as may be included with the spirit and scope of the invention defined by the appended claims. In addition, other methods and/or devices may be employed in the method and apparatus of the instant invention as claimed with similar results.

What is claimed is:

1. A method comprising:
brushing the inside surface of a cylindrical photoreceptor substrate.

2. The method of claim 1, further comprising spraying said inside surface.

3. The method of claim 1, further comprising coating the outside surface of said substrate after said cleaning step.

4. The method of claim 3, wherein said coating step occurs directly after said cleaning step.

5. The method of claim 3, wherein said coating step comprises coating with a photoconductive material.

6. A method of claim 1, wherein said brushing step comprises rotational motion.

7. The method of claim 6, wherein said brushing step further comprises translational motion.

8. The method of claim 1, wherein said cleaning step comprises translational motion.

9. The method of claim 1, further comprising: cleaning the outside surface of said substrate.

10. The method of claim 9, wherein said cleaning step comprises brushing the outside surface of said substrate.

11. The method of claim 9, wherein said cleaning step is substantially simultaneous with said brushing step.

12. The method of claim 1, further comprising immersing said substrate in a cleaning liquid during said brushing step.

13. The method of claim 12, wherein said immersing step occurs during said brushing step.

14. The method of claim 9, wherein said additional cleaning step is performed at a different location on said inside surface than said brushing step.

15. Apparatus comprising:
a brush for cleaning an inside surface of a cylindrical substrate photoreceptor.

16. The apparatus of claim 16, further comprising a cleaning element for cleaning the outside surface of the substrate.

17. The apparatus of claim 16, further comprising:
a container having said brush and said cleaning element disposed therein; and
a cleaning liquid disposed in said container.

18. The apparatus of claim 16, wherein said cleaning element comprises another brush.

19. The apparatus of claim 15, further comprising a rotator coupled to at least said brush.

20. The apparatus of claim 19, wherein said rotator comprises a motor.

21. The apparatus of claim 15, further comprising a reciprocator coupled to at least said brush.

22. The apparatus of claim 15, further comprising another brush for cleaning the outside substrate surface.

23. The apparatus of claim 22, wherein said other brush is disposed at a different height on said outside surface than said inside brush is on said inside surface.

24. The apparatus of claim 15, wherein said brush includes a helical arrangement of bristles.

25. A method comprising:
cleaning the inside surface of a cylindrical photoreceptor substrate; and
directly coating the outside surface of said substrate with a photoconductor.

26. The method of claim 25, wherein said cleaning step comprises brushing.

27. The method of claim 25, wherein said cleaning step comprises spraying.

28. The method of claim 25, wherein said cleaning step comprises motion.

29. The method of claim 25, further comprising the outside surfaces of said substrate.

30. Apparatus comprising:
a brush for cleaning the inside surface of a cylindrical substrate; and
a coater for coating the outside surface of said substrate with a photoconductor.

31. The apparatus of claim 30, further comprising a cleaning element for cleaning the outside surface of said substrate.

31. The apparatus of claim 30, further comprising:
a container having said brush and said cleaning element disposed therein; and
a cleaning liquid disposed in said container.

33. The apparatus of claim 30, further comprising another brush for cleaning the outside substrate surface.

34. The apparatus of claim 33, wherein said other brush is located on said outside surface at a different height than said inside brush is on said inside surface.
